(19) United States
(12) Patent Application Publication
(10) Pub. No.: US 2019/0177169 A1
(43) Pub. Date: Jun. 13, 2019

(54) MODIFIED GRAPHITE INTERCALATED COMPOUNDS AND METHODS OF MAKING AND USING THEM

(71) Applicant: MEGAMATTER, INC., San Luis Obispo, CA (US)

(72) Inventors: Philip COSTANZO, San Luis Obispo, CA (US); George DUBOIS, Nipomo, CA (US); Roopak MITRA, San Luis Obispo, CA (US); Arlin KRIGEL, Palo Alto, CA (US)

(73) Assignee: MegaMatter, Inc., San Luis Obispo, CA (US)

(21) Appl. No.: 16/309,590

(22) PCT Filed: Jun. 13, 2017
(86) PCT No.: PCT/US2017/037272

§ 371 Date: Dec. 13, 2018

Related U.S. Application Data
(60) Provisional application No. 62/349,263, filed on Jun. 13, 2016.

(51) Int. Cl. C01B 32/22; C08K 3/04; C08K 3/016; C08J 9/00

(52) U.S. Cl. CPC C01B 32/22; C08K 3/04; C08J 2325/06; C08J 9/0066; C08K 3/016

(57) ABSTRACT

Disclosed herein are directed to compositions containing one or more Graphite Intercalated Compounds (GICs), chemically associated with one or more salts. In some instances, the one or more salts anionic components are capable of modifying the one or more GICs via an oxidation process. In some embodiments, the one or more modified-GIC composition's overall composition has an acid content greater than or equal to the pre-existing acid content of the starting one or more GICs.

### CROSS REFERENCE TO RELATED APPLICATIONS

This application claims priority to U.S. Provisional Application No. 62/349,263 entitled “Inorganic and Organic Substances Combined for Novel Material” filed on Jun. 13, 2016 and is incorporated herein by reference in its entirety.

### FIELD

Disclosed herein are compositions useful as flame retardants, methods of making them as well as methods of using them. More particularly, the compositions disclosed herein contain one or more modified Graphite Intercalated Compounds (GICs). More particularly, the one or more GIC compositions include one or more GICs chemically associated with one or more salts. In some instances, each of the one or more GICs is modified via an oxidation process brought about by the salts anionic component.

### BACKGROUND

The flame retardant industry is a global, multi-billion dollar field. In recent years, manufacturers have increasingly sought safer, non-halogenated alternatives to comply with legislation and fulfill consumer demand. Many non-halogenated flame retardants require high loadings or expense to produce, rendering them impractical for commercial applications. The following patent describes a novel composition and production method which can be used, in certain applications, as an effective flame retardant for a variety of materials.

There is a continuing need for compositions which can be used, in certain applications, as an effective flame retardant for a variety of materials as well as methods of making and using them.

### SUMMARY

In its most general form, the material comprises one or more Graphite Intercalated Compounds (GICs), chemically associated with one or more salts, in which the salt's anionic components are capable of modifying the GIC via an oxidation process, and the modified-GIC composition's overall composition has an acid content greater than or equal to the pre-existing acid content of the starting GIC. The salt may be organic or inorganic in nature.

In certain embodiments, the modified-GIC composition may contain an excess of components present as a mixture, non-chemically associated with each other. In other embodiments, the modified-GIC composition may contain one or more additional processing aids, selected upon application. Various other embodiments are directed towards one or more base materials or substrates, including thermoset or thermoplastic polymers, and the aforementioned modified-GIC composition.

Some embodiments provide a modified-GIC composition comprising one or more Graphite Intercalated Compounds (GICs), having a pre-existing acid content; and one or more salt, wherein the one or more salt's anionic components are capable of modifying each of the one or more GICs via an oxidation process, wherein the one or more modified-GIC compositions has an acid content greater than or equal to the pre-existing acid content of the starting one or more GICs.

In some embodiments, the Graphite Intercalated Compound is Expandable Graphite.

In some embodiments, the Expandable Graphite is intercalated with anions of SOx, NOx, halogen, strong acids, or combinations thereof.

In some embodiments, each of the one or more salts comprises a cation selected from organic cations or inorganic cations.

In some embodiments, each of the one or more salts is an acid salt selected from: Acetic Acid, Acetylsalicylic Acid, Antimonic Acid, Antimonous Acid, Arsenic Acid, Ascorbic Acid, Azelaic Acid, Barbituric Acid, Benzilic Acid, Boric Acid, Bromic Acid, Bromous Acid, Carbonic Acid, Carbonous Acid, Chloric Acid, Chlorous Acid, Chromic Acid, Chromous Acid, Cinnamic Acid, Citric Acid, Cyanic Acid, Dichromic Acid, Disulfurous Acid, Dithionous Acid, Diuranic Acid, Ferricyanic Acid, Fluoric Acid, Fluorous Acid, Folic Acid, Formic Acid, Fumaric Acid, Gallic Acid, Gluconic Acid, Glutamic Acid, Glutaric Acid, Hexanoic Acid, Hydroarsenic Acid, Hydrobromic Acid, Hydrochloric Acid, Hydrocyanic Acid, Hydrofluoric Acid, Hydroiodic Acid, Hydronitric Acid, Hydrophosphoric Acid, Hydroselenic Acid, Hydrosulfuric Acid, Hypobromous Acid, Hypocarbonous Acid, Hypochlorous Acid, Hypochromous Acid, Hypofluorous Acid, Hypoiodous Acid, Hyponitrous Acid, Hypooxalous Acid, Hypophosphoric Acid, Hypophosphous Acid, Hyposulfurous Acid, Iodic Acid, lodous Acid, Lactic Acid, Malic Acid, Malonic Acid, Manganic Acid, Metastannic Acid, Molybdic Acid, Nitric Acid, Nitrous Acid, Oleic Acid, Oxalic Acid, Percarbonic Acid, Perchloric Acid, Perchromic Acid, Perfluoric Acid, Periodic Acid, Permanganic Acid, Pernitric Acid, Peroxydisulfuric Acid, Perphosphoric Acid, Persulfuric Acid, Pertechnetic Acid, Perxenic Acid, Phosphoric Acid, Phosphorous Acid, Phthalic Acid, Propiolic Acid, Propionic Acid, Pyroantimonic Acid, Pyrophosphoric Acid, Pyrosulfuric Acid, Rosolic Acid, Selenic Acid, Selenous Acid, Silicic Acid, Silicofluoric Acid, Silicous Acid, Stearic Acid, Sulfuric Acid, Sulfurous Acid, Tannic Acid, Tartartic Acid, Telluric Acid, Tellurous Acid, Tetraboric Acid, Tetrathionic Acid, Thiocyanic Acid, Thiosulfurous Acid, Titanic Acid, Trifluoroacetic Acid, Tungstic Acid, Uranic Acid, Uric Acid, Xenic Acid, or any combination thereof.

In some embodiments, each of the one or more salts is selected to provide an anionic component selected from Sulfite, Sulfate, Hyposulfite, Persulfate, Pyrosulfate, Disulfite, Dithionite, Tetrathionate, Thiosulfite, Hydrosulfate, Peroxydisulfate, Perchlorate, Hydrochlorate, Hypochlorite, Chlorite, Chlorate, Hyponitrite, Nitrite, Nitrate, Pernitrate, Carbonite, Carbonate, Hypocarbonite, Percarbonate, Oxalate, Acetate, Phosphate, Phosphite, Hypophosphite, Perphosphate, Hypophosphate, Pyrophosphate, Hydrophosphate, Hydrobromate, Bromite, Bromate, Hypobromite, Hypoiodite, lodite, Iodate, Periodate, Hydroiodate, Fluorite, Fluorate, Hypofluorite, Perfluorate, Hydrofluorate, Chromate, Chromite, Hypochromite, Perchromate, Hydroselenate, Selenate, Selenite, Hydronitrate, Borate, Molybdate, Perxenate, Silicofluorate, Tellurate, Tellurite, Tungstate, Xenate, Citrate, Formate, Pyroantimonate, Permanganate, Manganate, Antimonate, Antimonite, Silicate, Titanate, Arsenate, Pertechnetate, Hydroarsenate, Dichromate, Tetraborate, Metastannate, Hypooxalite, Ferricyanate, Cyanate, Silicite, Hydrocyanate, Thiocyanate, Uranate, Diuranate, or any combination thereof.

In some embodiments, at least one of the one or more salts is a charged polymer.

In some embodiments, an excess of the one or more GICs and the one or more salts are present as a mixture, non-chemically associated with each other.

Some embodiments further comprise one or more additional flame retardants or synergists, including but limited to: metal hydroxides and oxides, halogenated flame retardants, phosphate flame retardants, nitrogen flame retardants, smoke suppressants or any combinations thereof.

Some embodiments further comprise one or more additional processing aids or additives to improve material properties, including but not limited to: glass fibers, plasticizers, stabilizers, lubricants, emulsifiers, pigments, dyes, optical brighteners, anti-static agents, blowing agents, wetting agents, anti drip agents, or any combinations thereof.

Some embodiments further comprise one or more additional cations mixed or reacted with the one or more salt and the one or more GICs.

In some embodiments, the cations are selected from a group consisting of lithium, sodium, potassium, rubidium, beryllium, magnesium, calcium, strontium, barium, scandium, yttrium, titanium, zirconium, hafnium, vanadium, niobium, tantalum, chromium, molybdenum, tungsten, manganese, technetium, rhenium, iron, ruthenium, osmium, cobalt, rhodium, indium, nickel, palladium, platinum, copper, silver, gold, zinc, cadmium, mercury, boron, aluminum gallium, indium, thallium, carbon, silicon, germanium tin, lead, nitrogen, phosphorous, antimony, bismuth, sulfur, selenium, tellurium, polonium, chlorine, bromine, or any cation from the S, P and/or D block of the period table of the elements, including any combinations or derivatives thereof. Cations from the S, P, and/or D block of the periodic table include lithium, sodium, potassium, rubidium, beryllium, magnesium, calcium, strontium, barium, scandium, yttrium, titanium, zirconium, hafnium, vanadium, niobium, tantalum, chromium, molybdenum, tungsten, manganese, technetium, rhenium, iron, ruthenium, osmium, cobalt, rhodium, indium, nickel, palladium, platinum, copper, silver, gold, zinc, cadmium, mercury, boron, aluminum gallium, indium, thallium, carbon, silicon, germanium, tin, lead, nitrogen, phosphorous, antimony, bismuth, sulfur, selenium, tellurium, polonium, chlorine, and bromine. In some embodiments, the S, P, and/or D block cations are selected from lithium, sodium, potassium, magnesium, calcium, titanium, chromium, tungsten, manganese, iron, cobalt, nickel, palladium, platinum, copper, silver, gold, zinc, cadmium, boron, aluminum, tin, nitrogen, phosphorous, antimony, bismuth, sulfur, chlorine, and bromine. In some embodiments, the S, P, and/or D block cations are selected from Aluminum, Phosphorous, Nitrogen, Iron, Zinc, Magnesium, and/or Calcium.

Some embodiments provide a composition comprising a base material, and one or more modified-GIC compositions comprising one or more Graphite Intercalated Compounds (GICs), having a pre-existing acid content; and one or more salts, wherein the one or more salts anionic components are capable of modifying the GIC via an oxidation process, wherein the one or more modified-GIC compositions has an acid content greater than or equal to the pre-existing acid content of the starting one or more GICs.

In some embodiments, the base material is a polymer thermoplastic and/or thermoset resin, non-polymeric material, metal, metal-based material, wood, cellulosic-based material, a mineral, or mineral-based material.

In some embodiments, the one or more modified-GIC compositions are dispersed throughout the base material.

In some embodiments, the one or more modified-GIC compositions are applied to the base material as a coating.

In some embodiments, the one or more GIC compositions are formed into an article selected from the group consisting of fibers, films, foams, sheets, molded articles, and composites.

Some embodiments provide a method for producing a modified-GIC Composition, the method comprising mixing one or more GICs with one or more salts in a common medium and allowing the resultant mixture to react to form the modified-GIC compositions.

In some embodiments, the one or more GICs and one or more salts are homogenized by mixing.

In some embodiments, the one or more GICs and the one or more salts are combined together in water or a water-based solution, as the common medium, to create a liquid or slurry.

In some embodiments, each of the one or more GICs and each of the one or more salts are combined together in a non-water or a non-water based solution, as the common medium, to create a liquid or slurry.

Some embodiments further comprise physically manipulating one or more modified-GIC compositions by one or more of grinding, milling, or spray-drying to prepare powders of various particle size.

In some embodiments, the common medium is a polymer melt.

In some embodiments, wherein the common medium is gaseous such as, but not limited to, steam, sulfur dioxide, sulfur trioxide, oxides of nitrogen, aldehydes, ketones, halogens, or esters.

In some embodiments, the components are combusted.

In various other embodiments, the modified-GIC may be created in-situ. In some instances, one or more GICs (e.g. expanded graphite) and an excess amount of one or more salts are homogenized in a common medium to create a modified-GIC, while the excess of each of the one or more salts is left unreacted. In other embodiments, one or more GICs (e.g. expanded graphite) and an excess amount of the one or more salts are homogenized in a common medium to create the modified-GIC, and the excess of the one or more salts is precipitated.

Some embodiments provide a method for producing a polymer composition, comprising combining one or more GICs with one or more salts, in a polymer melt.

In some embodiments, the combining results in homogenization.

In some embodiments, the polymer composition is extruded, compounded, injection molded, and/or polymerized.

In some embodiments, the one or more GICs and the one or more salts are combined together as a mixture, before homogenization into the polymer melt.

Some embodiments provide a method for producing a polymer composition, the method comprising combining one or more GICs and one or more salts together, and homogenizing the combination around a polymer.

In some embodiments, the components are dip coated, spray coated, pan coated, powder coated, seed coated, roller brushed, spray coated, and/or stamped.

Some embodiments provide a modified-GIC prepared by homogenizing one or more GICs and one or more salts in a common medium and allowing the one or more GICs to react with the one or more salts.

The embodiments described herein are illustrative in nature only and additional embodiments will be appreciated without departing from the spirit and scope of this disclosure.

### BRIEF DESCRIPTION OF DRAWINGS

FIG. 1 is a graph depicting the XRD analysis of individual FR components and formulated FR of comparative examples 1 and 2 with examples 1 and 2.

FIG. 2 is a graph depicting XRD analysis of reacted components vs. mixed components for comparative example 3 and example 3.

FIG. 3 is a graph depicting XRD analysis of reacted components vs. mixed components for comparative example 4 and example 4.

FIG. 4 is a graph depicting XRD analysis of reacted components vs. mixed components for comparative example 5 and example 5.

FIG. 5 is a graph showing Flame Spread results of a 3rd-Party ASTM E84 Results.

FIG. 6 is a graph showing Smoke Developed results of a 3rd-Party ASTM E84 Results

### DETAILED DESCRIPTION

Described below is a novel composition comprising one or more salts and one or more graphite intercalated compounds, the combination of which produces an unexpected chemical interaction when prepared as described resulting in a modified-GIC or modified-GIC composition. Even more surprising, the resulting compound/composition, although difficult to characterize, can be used as an effective flame retardant in a wide variety of materials, in some instances benefitting from relatively low loadings and cost-effective price-points, as well as other benefits.

Generally, the modified-GIC composition disclosed herein comprises one or more Graphite Intercalated Compounds (GICs), chemically associated with one or more salts, in which the one or more salts' anionic components are capable of modifying, and in some embodiments have modified the one or more GICs via an oxidation process, and the modified-GIC composition's overall composition has an acid content greater than or equal to the pre-existing acid content of the starting one or more GICs. The one or more salts may be organic or inorganic in nature.

Other embodiments are directed towards methods of manufacturing and methods of incorporation of the modified-GIC composition into or onto another material. Generally, the disclosed one or more modified-GIC compositions are prepared by homogenizing one or more GICs and one or more salts in a common medium. In one such embodiment, each of the one or more GICs and each of the one or more salts are added directly to a polymer melt. In another embodiment, each of the one or more GICs and each of the one or more salts are added to water to create a solution or slurry. In further embodiments, the solution or slurry is dried and ground into a powder. In another embodiment, each of the one or more GICs and each of the one or more salts are mixed together and heated via advection, conduction, convection, and/or radiation to create the modified-GIC composition in-situ.

The disclosed modified-GIC compositions act as flame retardants, and are useful in a variety of applications. Various additional embodiments include articles of manufacture containing one or more modified-GIC compositions, including but not limited to: foams, fibers, films, sheets, molded articles, extruded articles, and composites.

It is to be understood that the disclosed compositions, methods, and uses are not limited to the particular compositions, methodologies or protocols described, as these may vary. It is also to be understood that the terminology used in this description is for the purpose of describing the particular versions or embodiments only, and is not intended to limit their scope which will be limited only by the appended claims.

It must also be noted that as used herein and in the appended claims, the singular forms “a”, “an”, and “the” include plural reference unless the context clearly dictates otherwise. Unless defined otherwise, all technical and scientific terms used herein have the same meanings as commonly understood by one of ordinary skill in the art. Any methods and materials similar or equivalent to those described herein can be used in the practice or testing of embodiments disclosed, the disclosed methods, devices, materials and examples described herein focus on certain exemplary and illustrative embodiments.

“Optional” or “optionally” means that the subsequently described event or circumstance may or may not occur, and that the description includes instances where the event occurs and instances where it does not.

“Substantially no” means that the subsequently described event may occur at most about less than 10% of the time or the subsequently described component may be at most about less than 10% of the total composition, in some embodiments, and in others, at most about less than 5%, and in still others at most about less than 1%.

“Flame retardant,” “flame resistant,” “fire resistant,” or “fire resistance,” may be tested by measuring the flame spread and/or after-burn time in accordance with the UL 94 test, ISO 11925-2 test, or ASTM E84 test.

In UL 94 test, the tested materials are given classifications of UL-94 V-0, UL-94 V-1 and UL-94 V-2 on the basis of the results obtained with the ten test specimens. Briefly, the criteria for each of these UL-94-V-classifications are as follows:

UL-94 V-0: the total flaming combustion for each specimen after removal of the ignition flame should not exceed 10 seconds and the total flaming combustion for 5 specimens should not exceed 50 seconds. None of the test specimens should release any drips which ignite absorbent cotton wool.

UL-94 V-1: the total flaming combustion for each specimen after removal of the ignition flame should not exceed 30 seconds and the total flaming combustion for 5 specimens should not exceed 250 seconds. None of the test specimens should release any drips which ignite absorbent cotton wool.

UL-94 V-2: the total flaming combustion for each specimen after removal of the ignition flame should not exceed 30 seconds and the total flaming combustion for 5 specimens should not exceed 250 seconds. Test specimens may release flaming particles, which ignite absorbent cotton wool.

In the ISO 11925-2 test, the tested materials are given the classification of Class E (Pass) or Class F (Fail). Briefly, a material is deemed to pass if flame spread is less than 150 mm within 20 seconds of ignition, and cotton paper below does not ignite.

In the ASTM E84 test, the tested materials are given the classification of Class A, Class B, or Class C. Briefly, the criteria for each classification is given as follows:

Class A: Flame Spread Index of 0-25; Smoke Developed Index of 0-450.

Class B: Flame Spread Index of 26-75; Smoke Developed Index of 0-450.

Class C: Flame Spread Index of 76-200; Smoke Developed Index of 0-450.

Fire resistance may also be tested by measuring after-burning time. These test methods provide a laboratory test procedure for measuring and comparing the surface flammability of materials when exposed to a prescribed level of radiant heat energy to measure the surface flammability of materials when exposed to fire. The test is conducted using small specimens that are representative, to the extent possible, of the material or assembly being evaluated. The rate at which flames travel along surfaces depends upon the physical and thermal properties of the material, product or assembly under test, the specimen mounting method and orientation, the type and level of fire or heat exposure, the availability of air, and properties of the surrounding enclosure. If different test conditions are substituted or the end-use conditions are changed, it may not always be possible by or from this test to predict changes in the fire-test-response characteristics measured. Therefore, the results are valid only for the fire test exposure conditions described in this procedure.

Disclosed herein are modified-GIC compositions containing one or more Graphite Intercalated Compounds (GICs), chemically associated with one or more salts. In some instances, the salt's anionic components modify the one or more GICs via an oxidation process. In some embodiments, the modified-GIC composition has an acid content greater than or equal to the original acid content of the starting GICs. Thus, the disclosed modified-GIC compositions are one or more modified GICs that result from the reaction between one or more GICs and one or more salts in a common medium, as discussed herein.

In its most general form, the modified-GIC composition comprises one or more Graphite Intercalated Compounds (GICs), chemically associated with one or more salts, in which the salts anionic components are capable of modifying the one or more GICs via an oxidation process, and the modified-GIC composition's overall composition has an acid content greater than or equal to the pre-existing acid content of the starting one or more GICs. The one or more salts may be organic or inorganic in nature.

In certain embodiments, the modified-GIC composition may contain an excess of components present as a mixture, non-chemically associated with each other. In other embodiments, the modified-GIC composition may contain one or more additional processing aids, selected upon application. Various other embodiments are directed towards one or more base materials or substrates, including thermoset or thermoplastic polymers, incorporating the one or more modified-GIC compositions into the polymer matrix or as a surface coating.

Other embodiments are directed towards methods of manufacturing and methods of incorporation. In the most general form, one or more GICs and one or more salts are homogenized in a common medium. In one such embodiment, each of the one or more GICs and each of the one or more salts are added directly to a polymer melt. In another embodiment, each of the one or more GICs and each of the one or more salts are added to water to create a solution or slurry. In further embodiments, the solution or slurry is dried and ground into a powder. In another embodiment, each of the one or more GICs and each of the one or more salts are mixed together and heated via advection, conduction, convection, and/or radiation to create one or more modified-GIC compositions in-situ.

Finally, various additional embodiments include articles of manufacture containing one or more modified-GIC compositions, including but not limited to: foams, fibers, films, sheets, molded articles, extruded articles, and composites.

Modification of carbon based materials, such as graphene, graphene oxide, expandable graphite and carbon nanotubes has been extensively demonstrated under a variety of conditions. One of the most popular methods, entitled Hummer's Method, employs a collection of acids that can randomly oxidize the carbon based material and insert oxygen containing functional groups such as alcohols, phenols, carboxylic acids, aldehydes and epoxides. The placement, as well as the number, of these functional group is random. The batch to batch variability is well-known and established in the literature. Furthermore, after a material, such as graphene, has been modified and is aged, those functional groups can be displaced or rearrange. These issues in controlling the type, frequency and location of functional groups results in difficulty in fully characterizing said materials. These difficulties hold true for the modified GICs. Thus, as used herein, “modified,” “modifying” or similar word with respect to the one or more GICs and resulting one or more modified-GIC compositions refers to these types of functionalizations that result from oxidative processes brought on by reaction with the one or more salts.

### Graphite Intercalated Compound

A Graphite Intercalated Compound (GIC) may include, any GIC compound, including, but not limited to graphite intercalated with at least one of a reduction compound or an oxidation compound. Reduction compounds may include metal and/or organic ions with a net positive charge. Oxidation compounds may include ionic, negatively charged components such as oxoacids, halogenated acids, other strong acids and the combination thereof. Some embodiments include graphite intercalated with sulfuric acid, nitric acid, and/or acetic acid, all of which are common and commercially available. In some embodiments, one or more of the GICs is an expandable graphite. In some embodiments, the Expandable Graphite is intercalated with anions of SOx, NOx, halogen, strong acids, or combinations thereof. Particularly well-suited GICs include expandable graphite, such as those commercially available from Asbury Carbons, Graftech, Nyacol, and other commercial sources. In some embodiments, the starting GIC has a known acid content between 1-20 wt % on average, most commonly between 5 and 10 wt %. In some embodiments, the starting acid content is about 1 wt %, about 5 wt %, about 10 wt %, about 20 wt % or any value or range of values between any two of those values.

### Salt

The salt may be any salt, provided that the anionic component is capable of modifying GICs via an oxidation process. As noted above, the particular modification is difficult to characterize, so it is discussed herein in terms of a modification via an oxidation process. The one or more salts may include an inorganic salt, an organic salt, or a combination thereof.

The one or more salts may include, but are not limited to acid salts selected from: Acetic Acid, Acetylsalicylic Acid, Antimonic Acid, Antimonous Acid, Arsenic Acid, Ascorbic Acid, Azelaic Acid, Barbituric Acid, Benzilic Acid, Boric Acid, Bromic Acid, Bromous Acid, Carbonic Acid, Carbonous Acid, Chloric Acid, Chlorous Acid, Chromic Acid, Chromous Acid, Cinnamic Acid, Citric Acid, Cyanic Acid, Dichromic Acid, Disulfurous Acid, Dithionous Acid, Diuranic Acid, Ferricyanic Acid, Fluoric Acid, Fluorous Acid, Folic Acid, Formic Acid, Fumaric Acid, Gallic Acid, Gluconic Acid, Glutamic Acid, Glutaric Acid, Hexanoic Acid, Hydroarsenic Acid, Hydrobromic Acid, Hydrochloric Acid, Hydrocyanic Acid, Hydrofluoric Acid, Hydroiodic Acid, Hydronitric Acid, Hydrophosphoric Acid, Hydroselenic Acid, Hydrosulfuric Acid, Hypobromous Acid, Hypocarbonous Acid, Hypochlorous Acid, Hypochromous Acid, Hypofluorous Acid, Hypoiodous Acid, Hyponitrous Acid, Hypooxalous Acid, Hypophosphoric Acid, Hypophosphous Acid, Hyposulfurous Acid, Iodic Acid, lodous Acid, Lactic Acid, Malic Acid, Malonic Acid, Manganic Acid, Metastannic Acid, Molybdic Acid, Nitric Acid, Nitrous Acid, Oleic Acid, Oxalic Acid, Percarbonic Acid, Perchloric Acid, Perchromic Acid, Perfluoric Acid, Periodic Acid, Permanganic Acid, Pernitric Acid, Peroxydisulfuric Acid, Perphosphoric Acid, Persulfuric Acid, Pertechnetic Acid, Perxenic Acid, Phosphoric Acid, Phosphorous Acid, Phthalic Acid, Propiolic Acid, Propionic Acid, Pyroantimonic Acid, Pyrophosphoric Acid, Pyrosulfuric Acid, Rosolic Acid, Selenic Acid, Selenous Acid, Silicic Acid, Silicofluoric Acid, Silicous Acid, Stearic Acid, Sulfuric Acid, Sulfurous Acid, Tannic Acid, Tartartic Acid, Telluric Acid, Tellurous Acid, Tetraboric Acid, Tetrathionic Acid, Thiocyanic Acid, Thiosulfurous Acid, Titanic Acid, Trifluoroacetic Acid, Tungstic Acid, Uranic Acid, Uric Acid, Xenic Acid, or any combination thereof. In some embodiments, the salts are acid salts of Sulfuric acid, Nitric acid, Phosphoric acid, Boric acid, Hydrochloric acid, Hypophosphoric acid, Nitrous acid, Phosphorous acid, Sulfurous acid, Tetraboric acid, Thiosulfurous acid, Uric acid, or any combination thereof. In some embodiments, the one or more salts are acid salts of Sulfuic acid, nitric acid, phosphoric acid, or any combination thereof. The particular acid may be selected keeping the desired application and other factors in mind. For example, depending on the substrate, different acids will be preferred. Nylon may do better with thiourea groups, while Polyester may do better with phosphoric. Cotton may do better with Phosphonium.

The one or more salts may contain one or more anionic components, provided that the anionic component is capable of modifying the one or more GICs via an oxidation process. The anionic component may include, but is not limited to: Sulfite, Sulfate, Hyposulfite, Persulfate, Pyrosulfate, Disulfite, Dithionite, Tetrathionate, Thiosulfite, Hydrosulfate, Peroxydisulfate, Perchlorate, Hydrochlorate, Hypochlorite, Chlorite, Chlorate, Hyponitrite, Nitrite, Nitrate, Pernitrate, Carbonite, Carbonate, Hypocarbonite, Percarbonate, Oxalate, Acetate, Phosphate, Phosphite, Hypophosphite, Perphosphate, Hypophosphate, Pyrophosphate, Hydrophosphate, Hydrobromate, Bromite, Bromate, Hypobromite, Hypoiodite, lodite, Iodate, Periodate, Hydroiodate, Fluorite, Fluorate, Hypofluorite, Perfluorate, Hydrofluorate, Chromate, Chromite, Hypochromite, Perchromate, Hydroselenate, Selenate, Selenite, Hydronitrate, Borate, Molybdate, Perxenate, Silicofluorate, Tellurate, Tellurite, Tungstate, Xenate, Citrate, Formate, Pyroantimonate, Permanganate, Manganate, Antimonate, Antimonite, Silicate, Titanate, Arsenate, Pertechnetate, Hydroarsenate, Dichromate, Tetraborate, Metastannate, Hypooxalite, Ferricyanate, Cyanate, Silicite, Hydrocyanate, Thiocyanate, Uranate, Diuranate, or any combination thereof.

The one or more salt's cation may comprise one or more inorganic or organic components, or combinations thereof. Examples of inorganic cations may include, but are not limited to: aluminum, boron, calcium, chromium, iron, lithium, magnesium, manganese, potassium, sodium, titanium, and/or zinc. Examples of organic cations may include-but are not limited to quaternary ammoniums.

Depending upon the application, each of the one or more salts may be chosen for price, processing, environmental or other constraints. In one embodiment, an inorganic salt comprises aluminum sulfate. In other embodiments, a blend of inorganic salts comprising aluminum sulfate, magnesium sulfate, and iron sulfate is used. In some embodiments, one or more inorganic salts and one or more organic salts are used.

In another embodiment, an organic salt comprising tetrakis hydroxymethyl phosphonium sulfate is used. In another embodiment, a combination of aluminum sulfate, iron sulfate, and tetrakis hydroxymethyl phosphonium sulfate is used.

In some embodiments, the salt could be a charged polymer, including but not limited to ionomers, such as pyrrolidone, polystyrene sulfonic acid and ion-exchange resins.

### Proportions

The one or more GICs and one or more salts may be combined together in various ratios, depending upon application and desired material properties. The one or more GICs and one or more salts will chemically associate to form the modified-GIC composition, so long as the proportions of the salt to the GIC are adjusted or present from a weight ratio of 0.1:99.9 to 99.9:0.1. In some embodiments, the range is 10:90 to 90:10. In some embodiments, the ratio of salt to GIC is about 60:40. In certain embodiments, an excess, unreacted amount of the one or more salts and one or more GICs may be present as a mixture. Certain overlap may be advantageous, depending upon the application's requirements.

### Preparation

The modified-GIC composition may be prepared in a variety of ways. In the most general form, one or more salts and one or more GICs are homogenized in a common medium. In some embodiments, the result can be dried and optionally further processed into a powder.

The common medium may be a polymer melt, water, water-based solvent, a solution or slurry made from water or a water-based solvent. In some embodiments, the common medium is steam. In some embodiments, the one or more salts may be heated to its softening or melting point and used as the common medium. Similarly, the one or more GICs can be is heated to its softening or melting point and used as the common medium.

In one embodiment, one or more salts and one or more GICs are added directly to a polymer melt.

In another embodiment, the one or more salts and the one or more GICs are mixed together beforehand, then added directly to a polymer melt.

In one embodiment, the one or more salts and one or more GICs are added to water or a water-based solvent to create a solution or slurry. In a variation upon this embodiment, the one or more salts and one or more GICs are added to water or a water-based solvent to create a solution or slurry, then dried and processed into a powder.

In another embodiment, the one or more salts and the one or more GICs are added to a solvent other than water such as acetone, C1-C4 alcohols, such as but not limited to isopropyl alcohol, aldehydes, ketones, or carboxylic acid derivatives, and, optionally, subsequently dried and processed into a powder.

In another embodiment, the one or more salts and the one or more GICs are mixed together and steamed. In a different embodiment, the one or more salts and the one or more GICs are mixed together, steamed, dried, and processed into a powder.

In an alternative embodiment, the one or more salts is heated to its softening or melting point, and the one or more GICs is incorporated into it. In a variation upon this embodiment, the salt is heated to its softening or melting point, the one or more GICs are incorporated into it, and the material is subsequently dried and ground.

In a different embodiment, the one or more GICs are heated to its softening or melting point, and the one or more salts are incorporated into it. In a variation, the one or more GICs are heated to its softening or melting point, the one or more salts are incorporated into it, and the material is subsequently dried and processed into a powder.

In other embodiments, the one or more GIC's are incorporated into an ionic liquid to create a solution or slurry, into which the one or more salts are incorporated. In a variation upon this embodiment, the one or more GICs are incorporated into an ionic liquid, into which the one or more salts are incorporated; the resulting composition is then dried, and processed into a powder.

In another embodiment, the one or more GICs and one or more salts are mixed together and heated via advection, conduction, convection, and/or radiation to create the modified-GIC in-situ in a common medium, such as water, steam, sulfur dioxide, sulfur trioxide, oxides of nitrogen, aldehydes, ketones, halogens, or esters.

In various other embodiments, the modified-GIC may be created in-situ as the one or more GICs are being prepared. In some instances, graphite and an excess amount of one or more salts are homogenized in a common medium to create the one or more GICs, while the excess one or more salts is left unreacted. In other embodiments, graphite and an excess amount of one or more salts are homogenized in a common medium to create the one or more GICs, and the excess one or more salts is precipitated.

While not wanting to be bound by theory, it is believed a surprising chemical reaction occurs that allows for intercalation between the one or more salts and the one or more GICs. By combining the components together within the same media, a chemical reaction occurs that allows for intercalation between the two species. This is observed through X-ray Diffraction (XRD) by the variation in scattering seen when comparing the original, unreacted materials with fully reacted material (i.e. modified-GIC composition), as described in Examples 1-5 below.

The above embodiments can be manufactured commercially using dry-blending or liquid blending equipment. Liquid solutions may be dried using commercial equipment, such as oven drying, spray drying, or drum drying. Powders may be further processed via physical manipulation by commercial milling, grinding, or shredding equipment.

### Application

In some embodiments, the one or more GIC Compositions may be applied as a coating on the surface of a material, or distributed throughout the matrix of a material. Coating methodologies include, but are not limited to: dip coating, spray coating, pan coating, powder coating, seed coating, roller brushing, paint brushing, stamping, screen printing, commercial printing, mechanical abrasion, or combinations thereof. Methods of application throughout the matrix of a material include, but are not limited to: mixing, compounding, extrusion, injection molding, seed polymerization, suspension polymerization, emulsion polymerization, lamination, or combinations thereof.

### Substrate Materials

In some other embodiments, the above described one or more modified-GIC compositions may be incorporated into or applied to other, base materials. Base materials can include, but are not limited to, polymer thermoplastic and/or thermoset resin, non-polymeric material, metal, metal-based material, wood, cellulosic-based material, a mineral, or mineral-based material. For example, and not limitation, the modified-GIC composition can be incorporate into a matrix such as polymer matrix or a cellulosic matrix. Further, the one or more modified-GIC compositions can be applied to the surfaces of a variety of materials (substrates) to form a surface coating. Surface coatings can occupy substantially all or the substrate or any portion thereof.

For example, the one or more modified-GIC compositions may be incorporated into a thermoset or thermoplastic polymer. Suitable thermosets include, but are not limited to: polyurethane, vulcanized rubber, bakelite, duroplast, urea-formaldehyde foam, melamine resin, diallyl-phthalate (DAP), epoxy resin, polyimide cyanate ester, polycyanurate, and polyester resins. In other embodiments, the polymers may thermoplastics, including but not limited to: acrylics, poly(methyl methacrylate) (PMMA) and acrylonitrile butadiene styrene (ABS), polyamides such as nylon, polybenzimidazole (PBI, short for Poly-[2,2′-(m-phenylen)-5,5′-bisbenzimidazole]), polyethylene (PE) including ultra-high molecular weight polyethylene (UHMWPE), high-density polyethylene (HDPE), medium-density polyethylene (MDPE), low-density polyethylene (LDPE) and (LLDPE), and cross-linked polyethylene (XLPE or PEX), polypropylene (PP), polystyrene including extruded polystyrene foam (XPS), expanded polystyrene foam (EPS), extruded polystyrene foam (XPS), polyvinyl chloride (PVC), polytetrafluoroethylene (PTFE), polyesters including polyethylene terephtalate (PET), polybutylene terephtalate (PBT), thermoplastic polyester elastomer (TPEE), thermoplastic polyurethanes (TPU), and polycarbonate (PC). In other embodiments, the polymer material may comprise blends of the polymers described above.

In further embodiments, the material may be a metal or metal-based product, such as aluminum, iron, or steel to be coated with a modified-GIC composition. In other embodiments, the material may be a wooden or otherwise cellulosic material, such as lumber, oriented strand board, particleboard, plywood, hemp, or cotton. In another embodiment, the material may be a mineral or mineral-based material, such as drywall.

The modified-GIC composition can be incorporated into the materials during the manufacturing process, or applied to them externally via known coating techniques. Incorporation of one or more modified GIC compositions into or onto a material or substrate imparts flame resistance to that material or substrate.

### Other Components

Various other components can be used in conjunction with one or more modified-GIC compositions to enhance efficacy, so long as they do not materially detract from the performance of the overall material. Thus, some embodiments include compositions including one or more modified-GIC compositions as described above and one or more additive or other components.

These other components may include, but are not limited to: halogenated flame retardants, such as hexabromocyclododecane (HBCD), Tetrabromobisphenol A (TBBPA), Tris (1-chloro-2-propyl) phosphate (TCPP); halogenated polymers, such as butadiene styrene brominated copolymer (PolyFR); phosphate flame retardants, such aluminum polyphosphate or ammonium polyphosphate; nitrogen flame retardants, such melamine polyphosphate; smoke suppressants such as zinc borates; mineral fillers, such as magnesium or aluminum hydroxide, or any combinations thereof.

The modified-GIC composition may also include additives to improve material properties, including but not limited to: glass fibers, plasticizers, stabilizers, lubricants, emulsifiers, pigments, dyes, optical brighteners, anti-static agents, blowing agents, wetting agents, coating agents, anti-drip agents, or any combinations thereof.

### Articles of Manufacture

Various other embodiments include articles of manufacture, including but not limited to foams, fibers, films, sheets, molded articles and extruded articles, and composites comprising the one or more modified-GIC compositions either within the body of the article itself or as a surface coating.

### EXAMPLES

While the modified-GIC compositions have been described in significant detail regarding certain embodiments, other variations are possible. To that end, the following non-limiting examples are provided to illustrate potential embodiments. They should not be interpreted as limiting in any way.

### Xrd Characterization Study

### Method

Examples (Ex) 1-5 and Comparative Examples (C. Ex) 1-5 were characterized through X-ray Powder Diffraction (XRD).

In Examples 1-5, as set forth in further detail below, a beaker was loaded with a salt, GIC (e.g. Expandable Graphite), and solvent (e.g. Water), and stirred at room temperature for 60 seconds. Next, the composition was placed in an oven overnight and dried at 140 C. The composition was further processed by physical manipulation including grinding or milling to prepare powders of various particle size.

### Comparative Examples 1-2

In Comparative Examples 1-2, the individual components (salt and GIC (e.g. Expandable Graphite)) were ground separately into powders of various particle size.

In Comparative Example 1, Aluminum Sulfate (0.48 g of SO₄) was ground and analyzed as described above.

In Comparative Example 2, Expandable Graphite (1 g) was ground and analyzed as described above.

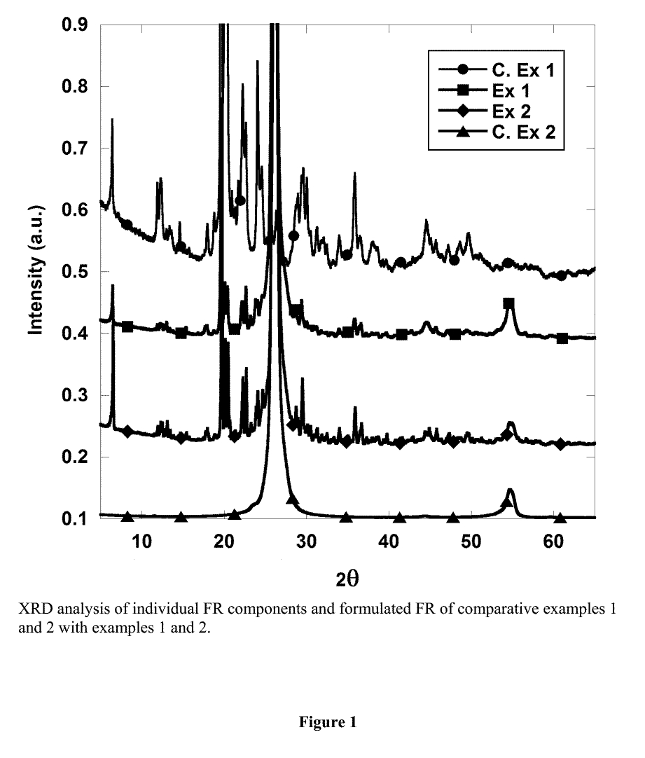

As expected and evidenced in FIG. 1, the Aluminum Sulfate displays a variety of intense scattering, while the Expandable Graphite has only two observable spectral features.

### Examples 1-2

In Examples 1 and 2, Aluminum Sulfate (0.48 g of SO₄ and 1.44 g of SO₄, respectively) were combined with Expandable Graphite (1 g) and water (5 mL) and processed in the method described above.

Surprisingly, by combining the components together within the same media, a chemical reaction occurs that allows for intercalation between the Aluminum Sulfate and the Expandable Graphite.

This is observed by the variation in scattering between the original materials and the fully reacted materials, as evidenced in FIG. 1. There are also peaks characteristic to the original Expandable Graphite material (C. Ex. 2) and Aluminum Sulfate (C. Ex. 1) due to varying the stoichiometric ratios of components utilized. In particular, the regions of 10-25 and 30-40 in Ex. 1 and Ex. 2 display clear shifts in scattering intensity indicating a change in the distance between molecular species, specifically the aluminum sulfate components. Between 40-50 there is a clear absence of peak intensity which correlates to the consumption of a starting material (aluminum sulfate) and the creation of a new molecular species (i.e. modified GIC-composition). The relative intensity of scattering between the peak at 26-30 and 50-60 indicate that the expandable graphite has been partially modified also indicating that a new molecular species has been prepared.

### Examples 3-5 and Comparative Examples 3-5

In Examples 3, 4, and 5, modified-GIC compositions of Aluminum Sulfate (0.66 g of SO₄) and Expandable Graphite (1 g), Magnesium Sulfate (0.66 g of SO₄) and Expandable Graphite (1 g), and Ammonium Sulfate (0.66 g of SO₄) and Expandable Graphite (1 g), respectively, were prepared as described above by loading a beaker with the salt, the GIC (e.g. Expandable Graphite), and solvent (e.g. Water) and stirred at room temperature for 60 seconds. Next, the composition was placed in an oven overnight and dried at 140 C. The composition was further processed by physical manipulation including grinding or milling to prepare powders of various particle size.

Comparative Examples 3-5 parallel Examples 3-5, using the same respective salt. In these comparative examples, the salt and GIC (e.g. Expandable Graphite) were ground separately, and subsequently loaded into a beaker and physically mixed together for 20 seconds until the contents were homogenized. That is, Comparative Examples 3, 4, and 5, contained the same components as Examples 3, 4, and 5, respectively, only mixed together separately as described above, without reaction.

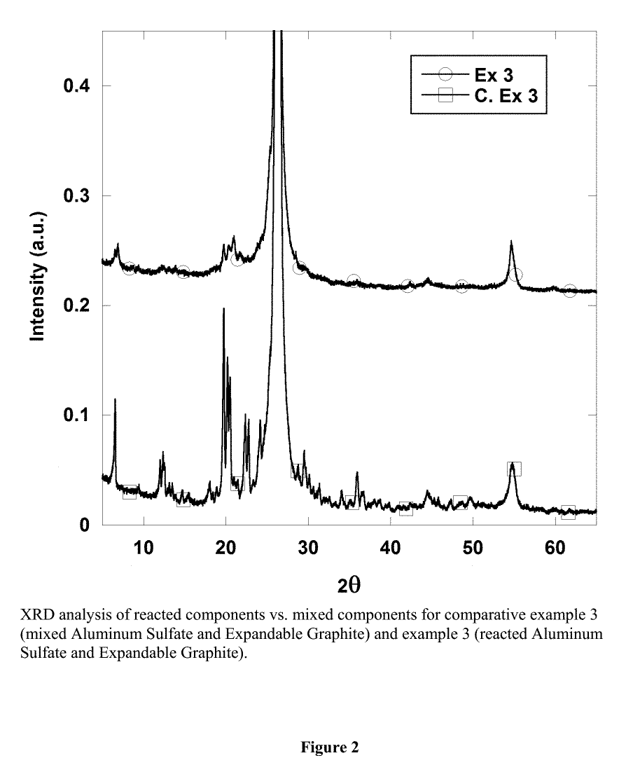

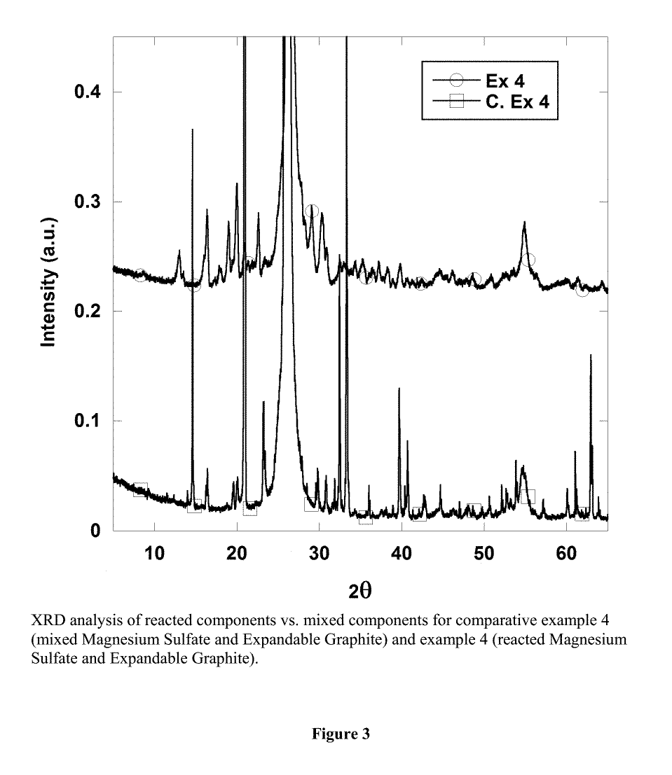

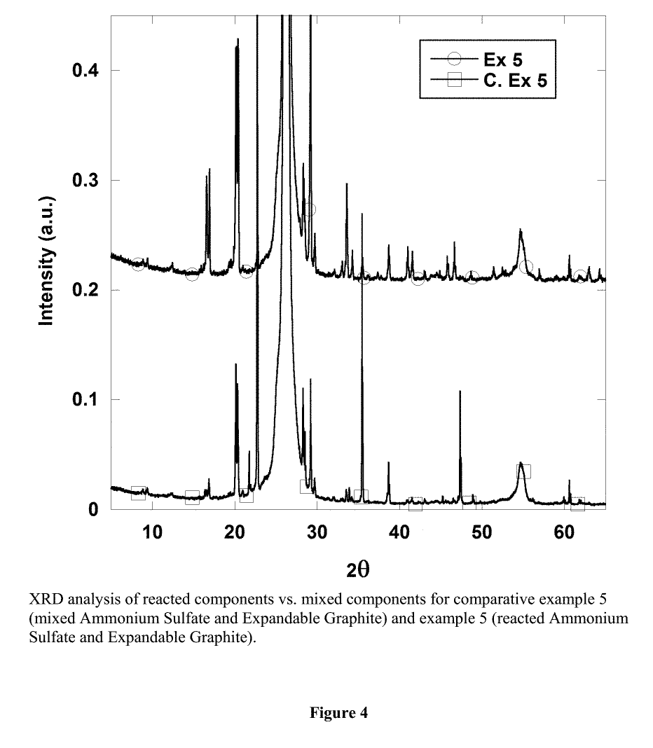

XRD analysis of Examples 3, 4, and 5 and Comparative Examples 3, 4, and 5 were run and juxtaposed against one another in FIGS. 2-4.

XRD analysis of Examples 3-5 shows significantly different scattering against Comparative Examples 3-5. Large differences in the crystallinity of the materials changes due to chemical processing is demonstrated by the loss of relevant peaks. Furthermore, new peaks indicate that a new chemical entity (the modified-GIC composition) is created during the processing that is related to the change in spacing between crystalline regions. These changes occur regardless of the cation while all anions were held constant to be sulfate anions.

### Intercalation Study

### Method

Another set of experiments compare the fire performance of reacted and unreacted (i.e. mixed) components in a simulated ISO 11925-2 test, and the effect of multiple cations on the material.

In all iterations, 6.5 inch×11 inch strips of glass-fiber mesh were cut and folded in half lengthwise, measuring 3.25 inches by 11 inches. Metal staples were fastened every 0.125 inches around the perimeter of the fabric to create a pouch.

Expandable Polystyrene (EPS) beads were expanded to a density of 1 pound per cubic foot, and were aged for three days at 80 Celsius to remove any residual pentane. Next, the EPS beads (78 wt %) were mixed with Silicone Oil (9 wt %) in a beaker to promote the adhesion of the powdered modified-GIC composition (prepared as described below). The Silicone-Oil-coated EPS beads were subsequently mixed with the powders and poured into the fiberglass pouches. Samples were tested to a modified ISO 11925-2 test, in which the time to self-extinguish was recorded. If a sample did not self extinguish, this was noted as DNSE.

The powdered modified-GIC compositions were prepared as follows:

In Examples 6-9, a beaker was loaded with a salt, Expandable Graphite, and solvent (10 mL of water) and allowed to stir at room temperature for 30 seconds. Next, the composition was placed in an oven overnight and dried at 140 C. The composition was further processed by physical manipulation including grinding or milling to prepare powders of various particle size.

In Comparative Examples 6-8, the salt and Expandable Graphite were ground separately, and subsequently loaded into a beaker and physically mixed together for 20 seconds until the contents were homogenized.

### Comparative Examples 6-8

In Comparative Example 6, Expandable Graphite (5 wt %) and Aluminum Sulfate (8 wt %) were mixed together and coated around the EPS beads, as described above. In Comparative Example 7, Expandable Graphite (5 wt %) and Magnesium Sulfate (8 wt %) were mixed together and coated around the EPS beads, as described above. As described in Table 1 below, these formulations took 36 and 33 seconds, respectively, to self extinguish. An additional control, Comparative Example 8, contained only Expandable Graphite (5 wt %). This formulation did not self extinguish.

### Examples 6-7

In Examples 6-7, Aluminum Sulfate and Magnesium Sulfate (8 wt % each, respectively), were reacted with Expandable Graphite (5 wt %) and coated around the EPS beads, as described above. Unexpectedly, these formulations took only 26 and 13 seconds to self extinguish, respectively, or 10 to 20 seconds less than the comparative examples. This demonstrates that processing the components together in a common medium is beneficial to the fire performance of the material.

TABLE 1
Effect of Processing Method on Time to Self-Extinguish

| | Ex 6 | C. Ex 6 | Ex 7 | C. Ex 7 | C. Ex 8 |
|---|---|---|---|---|---|
| | 206-B | 206-E | 206-C | 206-F | 213-G |
| EPS (wt %) | 78 | 78 | 78 | 78 | 86 |
| Silicone Oil (wt %) | 9 | 9 | 9 | 9 | 9 |
| Expandable Graphite (wt %) | 5 | 5 | 5 | 5 | 5 |
| Aluminum Sulfate (wt %) | 8 | 8 | | | |
| Magnesium Sulfate (wt %) | | | 8 | 8 | |
| Processing Method | Reacted | Mixed | Reacted | Mixed | Mixed |
| Time to Self Extinguish (s) | 26 | 36 | 13 | 33 | DNSE |

### Examples 8, 9, and 6

An additional study examined the effect of multiple cations on time to self extinguish. In Examples 6, Aluminum Sulfate (8 wt %) was reacted with Expandable Graphite (5 wt %), and coated around the EPS beads as described above. This formulation self-extinguished in 26 seconds. In Example 9, Iron Sulfate (8 wt %) was reacted with Expandable Graphite (5 wt %), and coated around the EPS beads as described above. This formulation self-extinguished in 42 seconds. However in Example 8, both Aluminum Sulfate (4 wt %) and Iron Sulfate (4 wt %) was reacted with Expandable Graphite (5 wt %) and coated around the EPS beads, as described above. Surprisingly, this formulation self-extinguished in 19 seconds, significantly faster than Examples 6 and 9. This data, as described in Table 2, demonstrates that including multiple cations in the formulation can be beneficial to the flame retardancy of the material.

TABLE 2
Effect of Multiple Cations on Time to Self-Extinguish

| | Ex 8 | Ex 9 | Ex 6 |
|---|---|---|---|
| | 215-2 | 213-A | 206-B |
| EPS (wt %) | 78 | 78 | 78 |
| Silicone Oil (wt %) | 9 | 9 | 9 |
| Expandable Graphite (wt %) | 5 | 5 | 5 |
| Aluminum Sulfate (wt %) | 4 | | 8 |
| Iron Sulfate (wt %) | 4 | 8 | |
| Preparation Method | Reacted | Reacted | Reacted |
| Time to Self Extinguish (s) | 19 | 42 | 26 |

### Polyurethane Foam Studies

### Method

Examples 10-14 and Comparative Examples 9-17 were prepared using commercially-available Polyurethane foam from the brand “Innovating Science.” In all iterations, equal parts by weight of Part A (mixed isocyanates) and Part B (amine catalysts) were poured into a beaker and stirred vigorously for 20 seconds. Additives were mixed together separately, then incorporated into the foam and stirred vigorously for another 20 seconds. Samples were poured into a mold measuring 200 mm×120 mm×50 mm and allowed to cure for 24 hours. Samples were subsequently removed and trimmed on all faces and sides using an exacto-knife to 90 mm×190 mm×10 mm. All samples were tested according to ISO 11925-2 protocol, except samples were shorter than the required length (250 mm). Time to self extinguish and flaming droplets was recorded, as was flame spread to the 150 mm mark.

### Comparative Examples 9-12

In Comparative Example 9, Aluminum Hydroxide (12 wt %) and Expandable Graphite (3 wt %) were incorporated into the Polyurethane foam. This formulation failed the ISO 11925-2 test and took 4 times longer than Example 1 to self-extinguish, demonstrating the material's anionic component cannot be basic.

In Comparative Example 10, Aluminum Sulfate (12 wt %) was incorporated into the Polyurethane foam. In Comparative Example 11, Aluminum Hydroxide (12 wt %) was incorporated into the Polyurethane foam. In Comparative Example 12, Expandable Graphite (3 wt %) was incorporated into the Polyurethane foam. All samples failed and did not self-extinguish, demonstrating the individual flame retardant components are not effective when used solely on their own.

### Example 10

In Example 10, Aluminum Sulfate (12 wt %) and Expandable Graphite (3 wt %) were incorporated into the Polyurethane foam. This formulation passed the ISO 11925-2 test and self-extinguished within 3 seconds, demonstrating improved performance when the anionic component is capable of chemically modifying the GIC via an oxidation process; and demonstrating that a synergistic effect occurs between the salt and GIC. This example also demonstrates the material is an effective flame retardant in Polyurethane foam.

TABLE 3
Flame Retardant Effect of Acidic vs. Basic Anion in Polyurethane Foam

| | Ex 10 | C. Ex 9 | | C. Ex 11 | C. Ex 12 |
|---|---|---|---|---|---|
| | 523-1 | 519-1 | C. Ex 10 | 524-2 | 523-2 |
| Polyurethane Part A (wt %) | 42.5 | 42.5 | 44 | 44 | 48.5 |
| Polyurethane Part B (wt %) | 42.5 | 42.5 | 44 | 44 | 48.5 |
| Expandable Graphite (wt %) | 3 | 3 | | | 3 |
| Aluminum Sulfate (wt %) | 12 | | 12 | | |
| Aluminum Hydroxide (wt %) | | 12 | | 12 | |
| ISO 11925-2 Result | Pass | Fail | Fail | Fail | Fail |
| Time to Self Extinguish (s) | 3 | 13 | DNSE | DNSE | DNSE |
| Flaming Droplets (#) | 0 | 0 | 0 | 0 | 0 |

### Example 11

In Example 11, Aluminum Sulfate (4 wt %), Iron Sulfate (4 wt %), Magnesium Sulfate (4 wt %), and Expandable Graphite (3 wt %) were incorporated into the Polyurethane foam. This formulation passed the ISO 11925-2 test and self-extinguished under 1 second, three times faster than Example 10. This again demonstrates the increased benefit of having multiple cations in the material.

TABLE 4
Flame Retardant Effect of Multiple Cations in Polyurethane Foam

| | Ex 11 | Ex 10 |
|---|---|---|
| | 519-3 | 523-1 |
| Polyurethane Part A (wt %) | 42.5 | 42.5 |
| Polyurethane Part B (wt %) | 42.5 | 42.5 |
| Expandable Graphite (wt %) | 3 | 3 |
| Aluminum Sulfate (wt %) | 4 | 12 |
| Iron Sulfate (wt %) | 4 | |
| Magnesium Sulfate (wt %) | 4 | |
| ISO 11925-2 Result | Pass | Pass |
| Time to Self Extinguish (s) | 0 | 3 |
| Flaming Droplets (#) | 0 | 0 |

### Examples 12-13

In Example 12, Tetrakis(Hydroxymethyl) Phosphonium Sulfate (THPS) (12 wt %) and Expandable Graphite (3 wt %) were incorporated into the Polyurethane foam. This formulation passed the ISO 11925-2 test and self-extinguished within 1 second, demonstrating the cation can be organic or inorganic, and can work in conjunction with GICs.

In Example 13, Tetrakis(Hydroxymethyl) Phosphonium Chloride (THPC) (12 wt %) and Expandable Graphite (3 wt %) were incorporated into the Polyurethane foam. This formulation passed the ISO 11925-2 test and self-extinguished within 1 second, demonstrating multiple acid sources work as the anion.

### Comparative Examples 13 and 14

In Comparative Examples 4 and 5, Tetrakis(Hydroxymethyl) Phosphonium Sulfate (THPS) (12 wt %) and Tetrakis(Hydroxymethyl) Phosphonium Chloride (THPC) (12 wt %), respectively, were incorporated into the Polyurethane foam. Neither sample passed the ISO 11925-2 test, sustaining significant material deformation as well. This data demonstrates the components are not effective on their own, and that a synergistic effect occurs when they are combined with the GIC.

TABLE 5
Flame Retardant Effect of Inorganic Cation
and Acid Source in Polyurethane Foam

| | Ex 12 | Ex 13 | C. Ex 13 | C. Ex 14 | C. Ex 11 |
|---|---|---|---|---|---|
| | 522-8 | 522-7 | 524-4 | 524-3 | 523-2 |
| Polyurethane Part A (wt %) | 42.5 | 42.5 | 44 | 44 | 48.5 |
| Polyurethane Part B (wt %) | 42.5 | 42.5 | 44 | 44 | 48.5 |
| Expandable Graphite (wt %) | 3 | 3 | | | 3 |
| THPS (wt %) | 12 | | | | |
| THPC (wt %) | | 12 | 12 | 12 | |
| ISO 11925-2 Result | Pass | Pass | Fail | Fail | Fail |
| Time to Self Extinguish (s) | 1 | 1 | 5 | 6 | DNSE |
| Flaming Droplets (#) | 0 | 0 | 0 | 0 | 0 |

### Example 14, and Comparative Examples 11, 15, 16, and 17

In Example 14, a blend of Aluminum Sulfate, Iron Sulfate, and Magnesium Sulfate (12 wt % total) and Expandable Graphite (3 wt %) was incorporated into the Polyurethane Foam. This formulation passed the ISO 11925-2 test, self-extinguishing in 1 second with no flaming droplets. By comparison, Comparative Example 17 achieved the same performance, but utilized three times the amount of Expandable Graphite (9 wt %).

Comparative Example 15, comprising a blend of Aluminum Sulfate, Iron Sulfate, and Magnesium Sulfate (15 wt % total) failed, along with Comparative Examples 11 and 16, comprising only Expandable Graphite (3 wt % and 6 wt %, respectively). This data demonstrates a fully-formulated material can provide a three-fold reduction in the amount of Expandable Graphite required.

TABLE 6
Flame Retardant Effect of Loading in Polyurethane Foam

| | C. Ex 15 | Ex 14 | C. Ex 11 | C. Ex 16 | C. Ex 17 |
|---|---|---|---|---|---|
| | 524-8 | 519-3 | 523-2 | 517-8 | 524-6 |
| Polyurethane Part A (wt %) | 42.5 | 42.5 | 48.5 | 47 | 45.5 |
| Polyurethane Part B (wt %) | 42.5 | 42.5 | 48.5 | 47 | 45.5 |
| Expandable Graphite (wt %) | 0 | 3 | 3 | 6 | 9 |
| Aluminum Sulfate (wt %) | 5 | 4 | 0 | 0 | 0 |
| Iron Sulfate (wt %) | 5 | 4 | | | |
| Magnesium Sulfate (wt %) | 5 | 4 | | | |
| ISO 11925-2 Result | Fail | Pass | Fail | Fail | Pass |
| Time to Self Extinguish (s) | DNSE | 1 | DNSE | 6 | 1 |
| Flaming Droplets (#) | 0 | 0 | 0 | 0 | 0 |

### EPDXY Study

### Method

Example 15 and Comparative Examples 18-20 were prepared using commercially-available Polyurethane foam from the manufacturer “Bob Smith Industries”. In all iterations, equal parts Part A (Bisphenol A Epoxy Resin) and Part B (hardener) were poured into a beaker and stirred vigorously for 20 seconds. Additives were prepared separately, and incorporated as powders into the Epoxy and stirred vigorously for 20 seconds. Samples were poured into a mold measuring 125 mm×13 mm×0.5 mm and allowed to cure for 24 hours. All samples were tested according to UL 94 protocol.

### Comparative Examples 18-20

In Comparative Example 18, Expandable Graphite (2 wt %) was incorporated into the Epoxy Resin. In Comparative Example 19, Expandable Graphite (4 wt %) was incorporated into the Epoxy Resin. In Comparative Example 20, Aluminum Sulfate (4 wt %) was incorporated into the Epoxy Resin. All Comparative Examples failed the UL 94 V0 test, as samples failed to self extinguish. From this data, it can be concluded neither Expandable Graphite nor Aluminum Sulfate is effective in Epoxy Resin when used solely on its own.

### Example 15

In Example 15, Aluminum Sulfate (2 wt %) and Expandable Graphite (4 wt %) were prepared and incorporated into the Epoxy Resin as described in the method above. The sample passed UL 94 and achieved V0. In T1, the sample immediately self extinguished, while in T2, the sample self extinguished within 3 seconds. There were no flaming droplets. From the data in Table 7, it is evident the described embodiment is an effective flame retardant in Epoxy Resin. Moreover, the data demonstrates at least a 50% reduction in Expandable Graphite can be achieved when paired with the appropriate salt, as evidenced by comparing Example 4 to Comparative Example 5 in the data below.

TABLE 7
Flame Retardant Effect in Epoxy Resin

| | Ex 15 | C. Ex 18 | C. Ex 19 | C. Ex 20 |
|---|---|---|---|---|
| | 205-3A | 205-5B | 205-4A | 205-7A |
| Epoxy Part A (wt %) | 47 | 49 | 48 | 48 |
| Epoxy Part B (wt %) | 47 | 49 | 48 | 48 |
| Aluminum Sulfate (g) | 4 | | | 4 |
| Expandable Graphite (g) | 2 | 2 | 4 | |
| UL 94 Result | V0 | Fail | Fail | Fail |
| Afterflame T1 (s) | 0 | 17 | 1 | DNSE |
| Afterflame T2 (s) | 3 | DNSE | DNSE | N/A |
| Afterflame T1 + T2 (s) | 3 | N/A | N/A | N/A |
| Flaming Droplets (#) | 0 | 0 | 0 | 0 |

### Expanded Polystyrene Foam Study

### Method

Examples 16-17 and Comparative Examples 21-23 were prepared using commercially-available Expandable Polystyrene (EPS) beads. In all iterations, the EPS beads were expanded to a density of 1 lb per cubic foot, and allowed to age for 24 hours. The beads were subsequently coated and allowed to dry before molding. All samples were sliced using a hot wire cutter, and tested in accordance with the ISO 11925-2 protocol.

### Examples 16-17, and Comparative Examples 21-23

In Example 16, Aluminum Sulfate (11 wt %), Expandable Graphite (7 wt %), and a binder (4 wt %) were coated around the EPS beads as described above. This sample passed the ISO 11925-2 test with 0 flaming droplets. In Example 17, Aluminum Sulfate (11 wt %) and Expandable Graphite (7 wt %) were coated around the EPS beads as described above. This sample also passed the ISO 11925-2 test, although consistency throughout the sample was decreased. In both samples, fusion of the beads were not affected. This data demonstrates the flame retardant is effective in Expanded Polystyrene foam.

The formulations were contrasted against Comparative Example 21 and 22, in which only Expandable Graphite (7 wt %) and only Aluminum Sulfate (11 wt %) were coated around the EPS beads. Both formulations failed, again demonstrating the individual components are not effective when utilized solely on their own.

TABLE 8
Flame Retardant Efficacy in Expanded Polystyrene Foam

| | Ex 16 | Ex 17 | C Ex 21 | C Ex 22 | C Ex 23 |
|---|---|---|---|---|---|
| EPS (wt %) | 78 | 82 | 93 | 89 | 91 |
| Expandable Graphite (wt %) | 7 | 7 | 7 | | 3.5 |
| Aluminum Sulfate (wt %) | 11 | 11 | | 11 | 5.5 |
| Binder (wt %) | 4 | | | | |
| ISO 11925-2 Result | Pass | Pass | Fail | Fail | Fail |

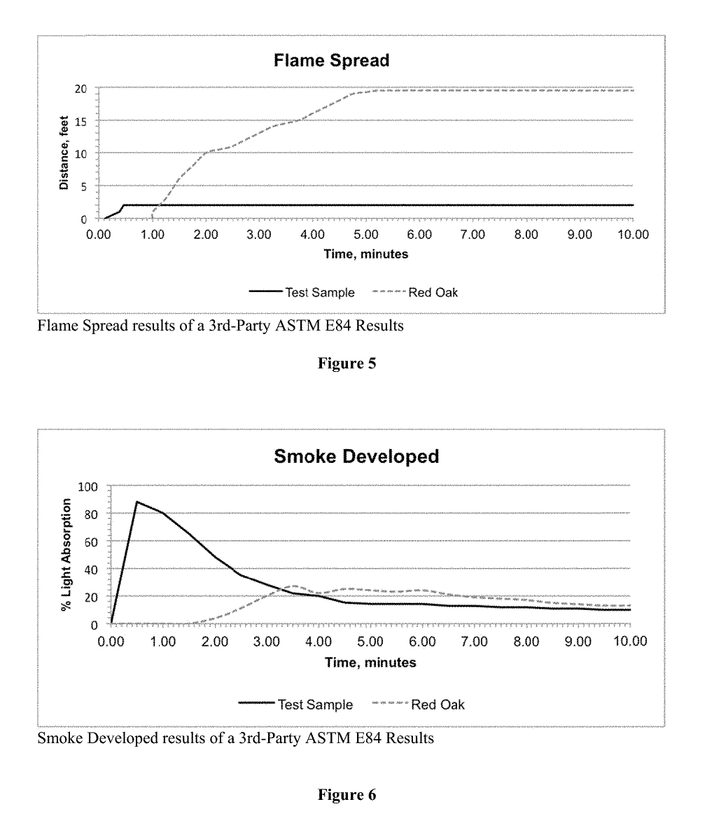

The formulation from Example 16 was further tested in accordance to ASTM E84 24 feet of EPS, 23″ wide by 1″ thick, was submitted in 3 foot long sections for testing at a 3rd party facility. According to the test criteria, the samples met the requirements for a “Class A” material, with a Flame Spread Index of 10, and a Smoke Developed Index of 170, as evidenced in FIGS. 5 and 6.

1.-38. (canceled)

39. A modified-GIC composition comprising:
one or more Graphite Intercalated Compounds (GICs), having a pre-existing acid content; and
one or more salts, wherein the one or more salt's anionic components are capable of modifying the GIC via an oxidation process,
wherein the one or more modified-GIC compositions has an acid content greater than or equal to the pre-existing acid content of the starting one or more GICs.

40. The composition of claim 39, wherein the Graphite Intercalated Compound is Expandable or Expanded Graphite.

41. The composition of claim 40, wherein the Expandable or Expanded Graphite is intercalated with anions of SOx, NOx, halogen, strong acids, or combinations thereof.

42. The composition of claim 39, wherein each of the one or more salts comprises a cation selected from organic cations or inorganic cations.

43. The composition of claim 39, wherein each of the one or more salts is an acid salt selected from: Acetic Acid, Acetylsalicylic Acid, Antimonic Acid, Antimonous Acid, Arsenic Acid, Ascorbic Acid, Azelaic Acid, Barbituric Acid, Benzilic Acid, Boric Acid, Bromic Acid, Bromous Acid, Carbonic Acid, Carbonous Acid, Chloric Acid, Chlorous Acid, Chromic Acid, Chromous Acid, Cinnamic Acid, Citric Acid, Cyanic Acid, Dichromic Acid, Disulfurous Acid, Dithionous Acid, Diuranic Acid, Ferricyanic Acid, Fluoric Acid, Fluorous Acid, Folic Acid, Formic Acid, Fumaric Acid, Gallic Acid, Gluconic Acid, Glutamic Acid, Glutaric Acid, Hexanoic Acid, Hydroarsenic Acid, Hydrobromic Acid, Hydrochloric Acid, Hydrocyanic Acid, Hydrofluoric Acid, Hydroiodic Acid, Hydronitric Acid, Hydrophosphoric Acid, Hydroselenic Acid, Hydrosulfuric Acid, Hypobromous Acid, Hypocarbonous Acid, Hypochlorous Acid, Hypochromous Acid, Hypofluorous Acid, Hypoiodous Acid, Hyponitrous Acid, Hypooxalous Acid, Hypophosphoric Acid, Hypophosphous Acid, Hyposulfurous Acid, Iodic Acid, Iodous Acid, Lactic Acid, Malic Acid, Malonic Acid, Manganic Acid, Metastannic Acid, Molybdic Acid, Nitric Acid, Nitrous Acid, Oleic Acid, Oxalic Acid, Percarbonic Acid, Perchloric Acid, Perchromic Acid, Perfluoric Acid, Periodic Acid, Permanganic Acid, Pernitric Acid, Peroxydisulfuric Acid, Perphosphoric Acid, Persulfuric Acid, Pertechnetic Acid, Perxenic Acid, Phosphoric Acid, Phosphorous Acid, Phthalic Acid, Propiolic Acid, Propionic Acid, Pyroantimonic Acid, Pyrophosphoric Acid, Pyrosulfuric Acid, Rosolic Acid, Selenic Acid, Selenous Acid, Silicic Acid, Silicofluoric Acid, Silicous Acid, Stearic Acid, Sulfuric Acid, Sulfurous Acid, Tannic Acid, Tartartic Acid, Telluric Acid, Tellurous Acid, Tetraboric Acid, Tetrathionic Acid, Thiocyanic Acid, Thiosulfurous Acid, Titanic Acid, Trifluoroacetic Acid, Tungstic Acid, Uranic Acid, Uric Acid, Xenic Acid, or any combination thereof.

44. The composition of claim 39, wherein each of the one or more salts is selected to provide an anionic component selected from Sulfite, Sulfate, Hyposulfite, Persulfate, Pyrosulfate, Disulfite, Dithionite, Tetrathionate, Thiosulfite, Hydrosulfate, Peroxydisulfate, Perchlorate, Hydrochlorate, Hypochlorite, Chlorite, Chlorate, Hyponitrite, Nitrite, Nitrate, Pernitrate, Carbonite, Carbonate, Hypocarbonite, Percarbonate, Oxalate, Acetate, Phosphate, Phosphite, Hypophosphite, Perphosphate, Hypophosphate, Pyrophosphate, Hydrophosphate, Hydrobromate, Bromite, Bromate, Hypobromite, Hypoiodite, Iodite, Iodate, Periodate, Hydroiodate, Fluorite, Fluorate, Hypofluorite, Perfluorate, Hydrofluorate, Chromate, Chromite, Hypochromite, Perchromate, Hydroselenate, Selenate, Selenite, Hydronitrate, Borate, Molybdate, Perxenate, Silicofluorate, Tellurate, Tellurite, Tungstate, Xenate, Citrate, Formate, Pyroantimonate, Permanganate, Manganate, Antimonate, Antimonite, Silicate, Titanate, Arsenate, Pertechnetate, Hydroarsenate, Dichromate, Tetraborate, Metastannate, Hypooxalite, Ferricyanate, Cyanate, Silicite, Hydrocyanate, Thiocyanate, Uranate, Diuranate, or any combination thereof.

45. The composition of claim 39, wherein the salt is a charged polymer.

46. The composition of claim 39, wherein excess GICs and salts are present as a mixture, non-chemically associated with each other.

47. The composition of claim 39, further comprising one or more additional flame retardants or synergists selected from: metal hydroxides and oxides, halogenated flame retardants, phosphate flame retardants, nitrogen flame retardants, smoke suppressants or any combinations thereof.

48. The composition of claim 39, further comprising one or more additional processing aids or additives to improve material properties selected from: glass fibers, plasticizers, stabilizers, lubricants, emulsifiers, pigments, dyes, optical brighteners, anti-static agents, blowing agents, wetting agents, anti drip agents, or any combinations thereof.

49. The composition of claim 39, further including one or more additional cations mixed or reacted with the one or more salts and the one or more GICs.

50. The composition of claim 49, wherein the cations are selected from a group consisting of lithium, sodium, potassium, rubidium, beryllium, magnesium, calcium, strontium, barium, scandium, yttrium, titanium, zirconium, hafnium, vanadium, niobium, tantalum, chromium, molybdenum, tungsten, manganese, technetium, rhenium, iron, ruthenium, osmium, cobalt, rhodium, indium, nickel, palladium, platinum, copper, silver, gold, zinc, cadmium, mercury, boron, aluminum gallium, indium, thallium, carbon, silicon, germanium tin, lead, nitrogen, phosphorous, antimony, bismuth, sulfur, selenium, tellurium, polonium, chlorine, bromine or the S, P and/or D block, including any combinations or derivatives thereof.

51. The composition of claim 39 further comprising: a base material.

52. The composition of claim 51, wherein the base material is a polymer thermoplastic and/or thermoset resin polymer thermoplastic and/or thermoset resin, non-polymeric material, metal, metal-based material, wood, cellulosic-based material, a mineral, or mineral-based material

53. The composition of claim 51, wherein the modified-GIC composition is dispersed throughout the base material.

54. The composition of claim 51, wherein the modified-GIC composition is applied to the base material as a coating.

55. The composition of claim 51, wherein composition is formed into an article selected from the group consisting of fibers, films, foams, sheets, molded articles, and composites.

56. The compositions of claim 39, wherein the components are advected, conducted, convected, radiated, or combusted.

57. A method for improving the flame retardancy of a graphite intercalated compound, the method comprising intercalating graphite with two or more different cations.

58. The composition of claim 57, wherein the cations are selected from a group consisting of lithium, sodium, potassium, rubidium, beryllium, magnesium, calcium, strontium, barium, scandium, yttrium, titanium, zirconium, hafnium, vanadium, niobium, tantalum, chromium, molybdenum, tungsten, manganese, technetium, rhenium, iron, ruthenium, osmium, cobalt, rhodium, indium, nickel, palladium, platinum, copper, silver, gold, zinc, cadmium, mercury, boron, aluminum gallium, indium, thallium, carbon, silicon, germanium tin, lead, nitrogen, phosphorous, antimony, bismuth, sulfur, selenium, tellurium, polonium, chlorine, bromine or the S, P and/or D block, including any combinations or derivatives thereof.

59. A method for producing a modified-GIC Composition, the method comprising:
mixing one or more GICs with one or more salts in a common medium;
allowing the resultant mixture to react to form the modified-GIC composition.
